(19) United States
(12) Patent Application Publication
(10) Pub. No.: US 2023/0289818 A1
(43) Pub. Date: Sep. 14, 2023

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(73) Assignee: TOYOTA JIDOSHA KABUSHIKI KAISHA, Toyota-shi (JP)

(21) Appl. No.: 18/150,151

(22) Filed: Jan. 4, 2023

(30) Foreign Application Priority Data
Mar. 9, 2022 (JP) 2022-036157

(51) Int. Cl. G06Q 30/018; G06Q 10/0835; G06Q 30/0601

(52) U.S. Cl. CPC G06Q 30/018; G06Q 10/0835; G06Q 30/0631

(57) ABSTRACT

An information processing device displays a first emissions amount which is an amount of carbon dioxide estimated to be emitted from a vehicle transporting commodities on a selling site of the commodities. A control unit of the information processing device acquires a first weight which is a total weight of commodities which are scheduled to be loaded on a first vehicle along with a first commodity and to be shipped when the first commodity is assumed to have been purchased at a present time point. The control unit estimates a second emissions amount which is an amount of carbon dioxide emitted from the first vehicle based on the first weight and a weight of the first commodity. The control unit calculates the first emissions amount based on the second emissions amount.

### CROSS-REFERENCE TO RELATED APPLICATION

This application claims priority to Japanese Patent Application No. 2022-036157 filed on Mar. 9, 2022, incorporated herein by reference in its entirety.

### BACKGROUND

### 1. Technical Field

The present disclosure relates to an information processing device and an information processing method.

### 2. Description of Related Art

Providing users with cooking methods of products and emissions of greenhouse gases when cooking is performed using the cooking method is known (for example, Japanese Unexamined Patent Application Publication No. 2010-044667 (JP 2010-044667 A)).

### SUMMARY

The present disclosure provides a technique capable of contributing to a decrease of an amount of carbon dioxide emitted at the time of transportation of commodities.

According to a first aspect of the present disclosure, there is provided an information processing device that displays a first emissions amount which is an amount of carbon dioxide estimated to be emitted from a vehicle transporting commodities on a selling site of the commodities. In this case, for example, the information processing device includes a control unit configured to perform: acquiring a first weight which is a total weight of commodities which are scheduled to be loaded on a first vehicle along with a first commodity and to be shipped when the first commodity is assumed to have been purchased at a present time point; estimating a second emissions amount which is an amount of carbon dioxide emitted from the first vehicle based on the first weight and a weight of the first commodity; and calculating the first emissions amount corresponding to the first commodity based on the second emissions amount.

According to a second aspect of the present disclosure, there is provided an information processing method of displaying a first emissions amount which is an amount of carbon dioxide estimated to be emitted from a vehicle transporting commodities on a selling site of the commodities. In this case, for example, the information processing method is performed by a computer and includes: acquiring a first weight which is a total weight of commodities which are scheduled to be loaded on a first vehicle along with a first commodity and to be shipped when the first commodity is assumed to have been purchased at a present time point; estimating a second emissions amount which is an amount of carbon dioxide emitted from the first vehicle based on the first weight and a weight of the first commodity; and calculating the first emissions amount corresponding to the first commodity based on the second emissions amount.

According to another aspect of the present disclosure, there is provided a program for causing a computer to perform the information processing method or a non-transitory storage medium storing the program.

According to the present disclosure, it is possible to provide a technique capable of contributing to a decrease of an amount of carbon dioxide emitted at the time of transportation of commodities.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of a selling system;

FIG. 2 is a diagram illustrating an example of a routine of transporting a commodity purchased from a selling site from a shipping source to a delivery destination according to an embodiment;

FIG. 3 is a diagram illustrating an example of a hardware configuration of a server device and a user terminal which are included in the selling system;

FIG. 4 is a block diagram illustrating an example of a functional configuration of the server device according to the embodiment;

FIG. 5 is a diagram illustrating an example of information which is stored in a user management database;

FIG. 6 is a diagram illustrating an example of information which is stored in a commodity management database;

FIG. 7 is a diagram illustrating an example of information which is stored in a shipping management database;

FIG. 8 is a diagram illustrating an example of information which is stored in an inter-area emission management database;

FIG. 9 is a diagram illustrating an example of information which is stored in an intra-area emission management database;

FIG. 10 is a diagram illustrating a predetermined period and a first period;

FIG. 11 is a diagram illustrating a correlation between a load weight and CO₂ emissions of a first vehicle;

FIG. 12 is a diagram illustrating a first example of a web page for a first commodity;

FIG. 13 is a diagram illustrating a second example of the web page for the first commodity;

FIG. 14 is a flowchart illustrating a process routine which is performed by the server device with a user's log-in on the selling site as a trigger; and

FIG. 15 is a diagram illustrating an example of a routine of transporting a commodity purchased from a selling site from a shipping source to a delivery destination according to a modified example.

### DETAILED DESCRIPTION OF EMBODIMENTS

An information processing device according to an aspect of the present disclosure is applied to a system that provides a commodity sales service on line. A user who uses an online sales service can access a selling site (a web site for selling commodities) via a web browser of a user terminal and purchase the commodities. A purchased commodity is transported from a shipping source to a delivery destination by a vehicle. A shipping source is, for example, a place serving as a start point of transportation of a commodity purchased by a user such as a manufacturing plant of the commodity or a warehouse in which the commodity is stored. A delivery destination is, for example, a place serving as an end point of transportation of the commodity purchased by the user such as the user's home, the user's workplace, or a gift receiver designated by the user.

Recently, a trend for reducing an amount of carbon dioxide (CO₂) (a first emissions amount) emitted from a vehicle when a commodity is transported from a shipping source to a delivery destination has become stronger. With this trend, displaying an amount of emitted carbon dioxide associated with transportation of a commodity on a selling site has been considered. When an amount of emitted carbon dioxide associated with transportation of a commodity is displayed on a selling site, the emissions amount needs to be estimated (predicted) in a stage (for example, a stage in which a user browses commodities in the selling site) before transportation of the commodity is actually performed.

On the other hand, in an information processing device according to the present disclosure, a control unit acquires a first weight which is a total weight of commodities which are scheduled to be loaded on a first vehicle along with a first commodity and to be shipped when it is assumed that the first commodity is purchased at a present time point.

The “first commodity” mentioned herein is a commodity which is displayed on a web page browsed by a user out of commodities which are being sold on a selling site and is a commodity which has not been yet purchased by the user. The “first vehicle” is a vehicle that transports commodities which have been purchased in the selling site in a predetermined period (commodities for which purchasing procedures have been completed within a predetermined period) with a shipping source as a start point. The “predetermined period” is a period which is determined such that the commodities purchased in the selling site in the predetermined period are loaded on the first vehicle and shipped at a predetermined shipping timing. Commodities which are scheduled to be loaded on the first vehicle along with the first commodity and to be shipped are commodities which have been purchased in the selling site in a first period from the start time of the predetermined period to a present point of time in the predetermined period. The commodities purchased in the first period include commodities purchased by users other than the user in addition to commodities purchased by the user.

In an example of a selling site in which shipping is performed at 16:00 every day and 30 minutes is required for shipping preparation operations (such as picking and packing of commodities), commodities purchased in the selling site in a period from 15:31 of the previous day to 15:30 of that day are loaded on the first vehicle and shipped at 16:00 of that day. In this case, the period from 15:31 of the previous day to 15:30 of that day corresponds to the predetermined period. When a user browses the first commodity in the selling site at 14:00 of that day which is a present point of time, commodities purchased in the selling site in a period from 15:31 of the previous day to 14:00 of that day correspond to the commodities which are scheduled to be loaded on a first vehicle along with a first commodity and to be shipped. In this case, the period from 15:31 of the previous day to 14:00 of that day corresponds to the first period.

In the information processing device according to the present disclosure, when a first weight is acquired, a control unit estimates a second emissions amount which is an amount of carbon dioxide emitted from the first vehicle based on the first weight and the weight of the first commodity. The control unit calculates an estimated value of an emissions amount (a first emissions amount) which is an amount of carbon dioxide emitted when the first commodity is transported from a shipping source to a delivery destination based on the estimated second emissions amount. Accordingly, it is possible to estimate the first emissions amount corresponding to the total weight of commodities which are scheduled to be loaded on the first vehicle at the timing at which a user browses the first commodity in the selling site.

When the user is browsing the first commodity in the selling site, there is a likelihood that another user will purchase a commodity in the selling site in a period from start of browsing to the present point of time. In this case, when the user is browsing the first commodity in the selling site, the first weight changes. There is also a likelihood that an end timing of the predetermined period will come in the period from start of browsing of the user to the present point of time. In this case, at the end timing of the predetermined period (a start timing of a next predetermined period), the first weight is reset, and a total weight of commodities (commodities which are shipped at the next shipping timing) which have been purchased in the selling site from the end timing of the predetermined period to the present point of time becomes the first weight. As a result, when the user is browsing the first commodity in the selling site, the first weight changes.

Therefore, when the first weight changes, the control unit of the information processing device according to the present disclosure may perform re-estimating the second emissions amount based on the changed first weight and re-calculating the first emissions amount based on the re-estimated second emissions amount. Accordingly, it is possible to present the first emissions amount corresponding to the changed first weight to a user even when the first weight changes while the user is browsing the first commodity in the selling site.

Here, a method of transporting the first commodity from a shipping source to a first base using a first vehicle, transporting the first commodity from the first base to a second base using a second vehicle, and transporting the first commodity from the second base to a delivery destination using a third vehicle may be considered as a first method of transporting the first commodity from the shipping source to the delivery destination. The first base is a business office of a delivery agent (for example, a delivery center) that takes charge of inter-area transportation from an area in which the shipping source is located to an area in which the delivery destination is located. An area mentioned herein is, for example, an individual geographical subarea when a territory is divided into geographical areas taken charge of by the bases of a delivery agent. In the first base, the first commodity is transferred from the first vehicle to the second vehicle. Since commodities transported from the first base to the second base include a large amount of commodities transported from various other shipping sources in addition to the first commodity, a large vehicle is used as the second vehicle.

The second base is a business office of a delivery agent that takes charge of intra-area transportation in an area in which the delivery destination is located. In the second base, commodities transported by the second vehicle are sorted by sections of the delivery destination and are transferred to small vehicles taking charge of delivery in the sections. At this time, the first commodity is loaded on the third vehicle taking charge of delivery in the section including the delivery destination of the first commodity and is delivered to the delivery destination. A section mentioned herein is an individual geographical subarea when the corresponding area is divided into a plurality of geographical subareas in consideration of efficiency of delivery work by the delivery agent or the like.

When the first commodity is transported using the first method, the control unit of the information processing device according to the present disclosure may calculate the first emissions amount by summing the second emissions amount, a third emissions amount which is an amount of carbon dioxide estimated to be emitted from the second vehicle when the first commodity is transported from the first base to the second base, and a fourth emissions amount which is an amount of carbon dioxide estimated to be emitted from the third vehicle when the first commodity is transported from the second base to the delivery destination.

In the first method, there is a high likelihood that a timing at which commodities to be loaded on the second vehicle in the first base are determined and a timing at which commodities to be loaded on the third vehicle in the second base are determined will be later than the timing at which a user browses the first commodity in the selling site. Accordingly, it is difficult to estimate the amount of carbon dioxide emitted from the second vehicle when the first commodity is transported from the first base to the second base and the amount of carbon dioxide emitted from the third vehicle when the first commodity is transported from the second base to the delivery destination using the same method as calculating the second emissions amount at the timing at which the user browses the first commodity in the selling site.

Therefore, when the first commodity is transported using the first method, the control unit of the information processing device according to the present disclosure may use a historical average value of amounts of carbon dioxide emitted when the second vehicle has actually traveled from the first base to the second base as the third emissions amount. The control unit of the information processing device according to the present disclosure may use a historical average value of amounts of carbon dioxide emitted when the third vehicle has actually traveled from the second base to the delivery destination (or a section of the delivery destination) as the fourth emissions amount. Accordingly, it is possible to secure estimation accuracy of the first emissions amount.

A method of transporting the first commodity from the shipping source to the third base using the first vehicle and transporting the first commodity from the third base to the delivery destination using a fourth vehicle may be considered as a second method of transporting the first commodity from the shipping source to the delivery destination. There is a high likelihood that the second method will be employed when a warehouse in which various commodities which are sold in the selling site are stored or the like serves as the shipping source of the first commodity. In other words, there is a high likelihood that the second method will be employed when an amount of commodities shipped from the shipping source is large. This is because the method of directly transporting commodities from the shipping source to the area of the delivery destination using one vehicle is more efficient than the method of transporting the commodities from the shipping source to the area of the delivery destination via the first base (a method of transferring the commodities from the first vehicle to the second vehicle in the first base and transporting the commodities to the area of the delivery) similarly to the first method when the amount of commodities shipped from the shipping source is large. Similarly to the second base in the first method, the third base in the second method is a base taking charge of intra-area transportation in the area in which the delivery destination is located. In the third base, the commodities transported by the first vehicle are sorted by sections including the delivery destinations and are transferred to small vehicles taking charge of delivery in the corresponding sections. At this time, the first commodity is loaded on the fourth vehicle taking charge of delivery in the section including the delivery destination of the first commodity and is delivered to the delivery destination.

When the first commodity is transported using the second method, the control unit of the information processing device according to the present disclosure may calculate the first emissions amount by summing the second emissions amount and a fifth emissions amount which is an amount of carbon dioxide estimated to be emitted from the fourth vehicle when the first commodity is transported from the third base to the delivery destination.

In the second method, there is a high likelihood that a timing at which commodities to be loaded on the fourth vehicle in the third base are determined will be later than the timing at which the user browses the first commodity in the selling site. Accordingly, it is difficult to estimate the amount of carbon dioxide emitted from the fourth vehicle when the first commodity is transported from the third base to the delivery destination using the same method as calculating the second emissions amount at the timing at which the user browses the first commodity in the selling site.

Therefore, when the first commodity is transported using the second method, the control unit of the information processing device according to the present disclosure may use a historical average value of amounts of carbon dioxide emitted when the fourth vehicle has traveled actually from the third base to the delivery destination (or the section of the delivery destination) as the fifth emissions amount. Accordingly, it is possible to secure estimation accuracy of the first emissions amount even when the first commodity is transported using the second method.

In a vehicle used to transport commodities or the like such as the first vehicle, the amount of carbon dioxide emitted from the vehicle per unit distance (for example, 1 km) (hereinafter also referred to as a “unit emissions amount”) trends to be substantially constant regardless of the magnitude of the load weight when the load weight is equal to or greater than a predetermined threshold value. Therefore, the control unit of the information processing device according to the present disclosure may estimate that the second emissions amount is a predetermined minimum value (for example, “0”) when the first weight is equal to or greater than a predetermined threshold value. In this configuration, the control unit of the information processing device according to the present disclosure may display recommendation information for recommending purchasing of the first commodity on the selling site in correlation with the first commodity when it is estimated that the second emissions amount is the predetermined minimum value. The recommendation information may include, for example, information for recommending purchasing of the first commodity until a first time prior to a shipping timing. A “first time” mentioned herein corresponds to an end timing of the predetermined period. Accordingly, it is possible to attract the user's attention to purchase of the first commodity at the timing at which the second emissions amount becomes the predetermined minimum value.

Hereinafter, specific embodiments of the present disclosure will be described with reference to the accompanying drawings. A hardware configuration, a module configuration, a functional configuration, and the like described in the embodiments are not intended to limit the technical scope of the present disclosure thereto unless otherwise mentioned.

### EMBODIMENTS

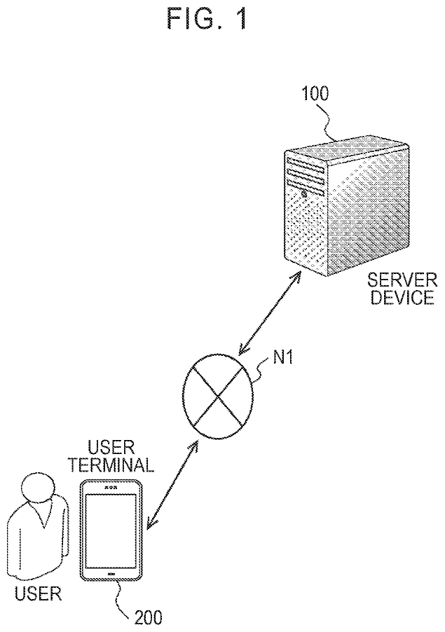

In the following embodiments, it is assumed that the information processing device according to the present disclosure is applied to a system for providing a sales service of commodities on line (hereinafter also referred to as a “selling system”). FIG. 1 is a diagram schematically illustrating the selling system according to this embodiment. The selling system according to this embodiment includes a server device 100 and a user terminal 200. The server device 100 and the user terminal 200 are connected to each other via a network N1. In the example illustrated in FIG. 1, only one user terminal 200 is illustrated, but user terminals 200 corresponding to the number of users of the selling service are included in the selling system.

The server device 100 is a computer that presents at least one commodity to a user and sells the commodity to the user in response to a purchase request from the user. In this embodiment, the server device 100 is configured to be able to execute a web server that performs interactions with the user terminal 200. When a user accesses the web server using a browser of the user terminal 200, the server device 100 is configured to execute a web server for interacting with the user terminal 200. When a user accesses the web server via a browser of the user terminal 200, the server device 100 displays a web page of a selling site of commodities (a web page for selling commodities) on the browser of the user terminal 200. The server device 100 receives a purchase request of a commodity displayed on the web page from the user terminal 200 and performs payment of the commodity. When the payment of the commodity is completed, the server device 100 performs a process of transporting the commodity to a delivery destination. A method of performing the process associated with selling and transportation of a commodity is not particularly limited and can employ an existing method.

The server device 100 according to this embodiment also has a function of presenting an amount of carbon dioxide (a first emissions amount) which is estimated to be emitted from a vehicle at the time of transportation from a shipping source to a delivery destination to a user as for a commodity (a first commodity) displayed in a web page browsed by the user out of commodities which are sold in the selling site. When a plurality of types of first commodities is displayed in the web page browsed by the user in the selling site, the first emissions amount is displayed for each of the first commodities. The shipping source is a manufacturing plant of the first commodity, a warehouse in which the first commodity is stored, or the like. The delivery destination is a place which is registered in advance in the server device 100 by the user. For example, when the user performs member registration in the selling site, a delivery destination designated by the user is registered in the server device 100. The method of estimating the first emissions amount will be described later.

The user terminal 200 is a computer that is used by a user who uses the selling site. The user can access the selling site using a browser of the user terminal 200 and browse a web page of commodities which are sold in the selling site or request purchase of a commodity displayed in the web page. In this embodiment, the user may select a commodity or purchase a commodity with reference to a first emissions amount displayed in the web page of the selling site.

Method of Transporting Commodity

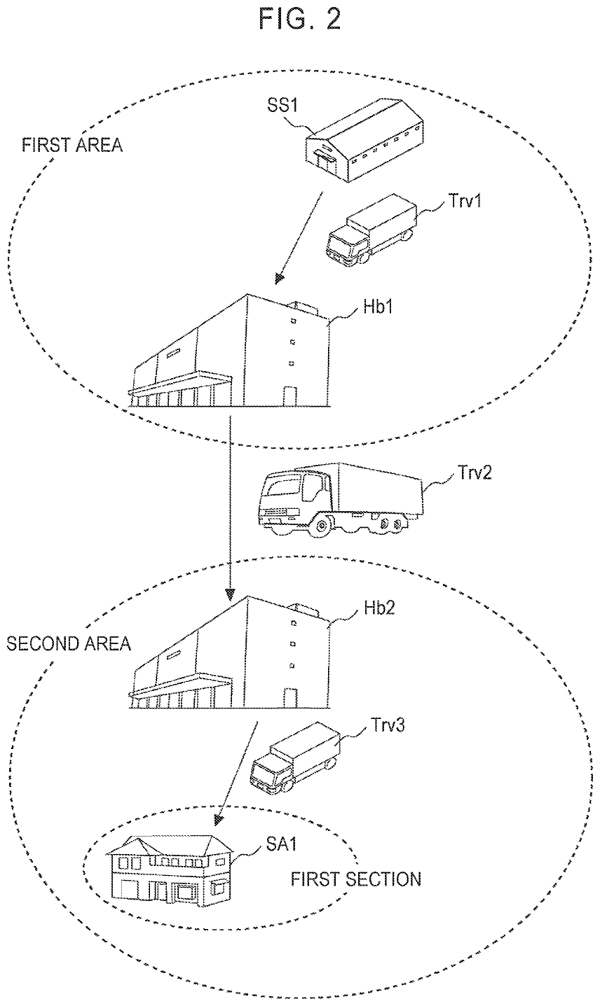

A method of transporting a commodity purchased in the selling site according to this embodiment will be described below with reference to FIG. 2. FIG. 2 is a diagram illustrating an example of a routine of transporting a commodity from a shipping source to a delivery destination. In this embodiment, it is assumed that commodities which are sold in the selling site are shipped from a shipping source SS1 in FIG. 2.

As illustrated in FIG. 2, a commodity purchased in the selling site according to this embodiment is transported from the shipping source SS1 to a first base Hb1 using a first vehicle Trv1, is transported from the first base Hb1 to a second base Hb2 using a second vehicle Trv2, and is transported from the second base Hb2 to a delivery destination SA1 using a third vehicle Trv3. In this embodiment, the first vehicle Trv1, the second vehicle Trv2, and the third vehicle Trv3 may be collectively referred to as vehicles Try.

The first base Hb1 is a business office of a delivery agent (for example, a delivery center) that takes charge of inter-area transportation from a first area in which the shipping source SS1 is located to a second area in which the delivery destination SA1 is located. An area mentioned herein is, for example, an individual geographical area when a territory is divided into geographical areas taken charge of by the business offices of a delivery agent. In the first base Hb1, a commodity transported from the shipping source SS1 is transferred from the first vehicle Trv1 to the second vehicle Trv2. Commodities loaded on the second vehicle Trv2 include commodities transported from other shipping sources (commodities of which a shipping source is located in the first area and a delivery destination is located in the second area) in addition to the commodities transported from the shipping source SS1. Accordingly, a relatively large transportation vehicle is used as the second vehicle Trv2.

The second base Hb2 is a business office of a delivery agent that takes charge of transportation (delivery) in the second area. In the second base Hb2, commodities transported by the second vehicle Trv2 are sorted by sections of the delivery destinations and are transferred to small vehicles taking charge of delivery in the sections. At this time, the commodities transported from the shipping source SS1 are loaded on the third vehicle Trv3 taking charge of delivery in a first section including the delivery destination SA1 of the commodity and is delivered to the delivery destination SA1. A section mentioned herein is an individual geographical subarea when the corresponding area is divided into a plurality of geographical subareas. The method of dividing an area into sections is determined, for example, in consideration of efficiency of delivery work by the delivery agent or the like.

Here, transportation of the commodity from the shipping source SS1 to the delivery destination SA1 may be performed by one delivery agent or may be performed by a plurality of delivery agents. In this embodiment, it is assumed that transportation form the shipping source SS1 to the first base Hb1 by the first vehicle Trv1 is performed by an agent that manages the shipping source SS1 (for example, a vendor of commodities which are sold in the selling site). It is also assumed that transportation from the first base Hb1 to the delivery destination SA1 by the second vehicle Trv2 and the third vehicle Trv3 is performed by an agent (for example, a delivery agent) other than the agent that manages the shipping source SS1.

The second area in FIG. 2 has a concept that collectively refers to a plurality of areas which may serve as an area including the delivery destination SA1 of the commodities, and the position of the area corresponding to the second area may change depending on the position of the delivery destination SA1. Therewith, a position of a section corresponding to the first section and a business office corresponding to the second base Hb2 may also change.

Configuration of Selling System

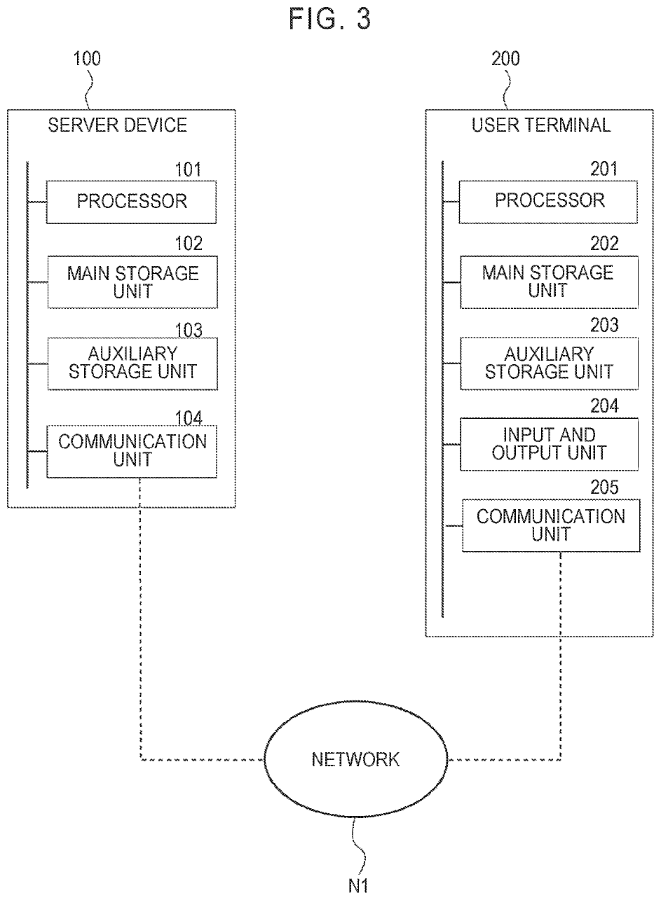

FIG. 3 is a diagram illustrating an example of a hardware configuration of the server device 100 and the user terminal 200 which are included in the selling system.

The server device 100 is a computer that is managed by an operator of the selling site, a vendor of commodities which are sold in the selling site, or the like and corresponds to an “information processing device” in the claims. The server device 100 provides information of commodities sold in the selling site to a user via the browser of the user terminal 200. The server device 100 may be configured to realize a web server for interacting with the user terminal 200. In this case, the user terminal 200 can present the user a web page in which information of commodities is displayed by accessing the web server using the browser. “Information of commodities” in this embodiment includes a first emissions amount in addition to photographs of the commodities, explanations of the commodities, prices of the commodities, and the like. The first emissions amount is an amount of carbon dioxide which is estimated to be emitted from a vehicle Try when the commodities are transported from the shipping source SS1 to the delivery destination SA1. The first emissions amount is an amount obtained by summing an amount of carbon dioxide (a second emissions amount) which is estimated to be emitted from the first vehicle Trv1 when the commodities are transported from the shipping source SS1 to the first base Hb1, an amount of carbon dioxide (a third emissions amount) which is estimated to be emitted from the second vehicle Trv2 when the commodities are transported from the first base Hb1 to the second base Hb2, and an amount of carbon dioxide (a fourth emissions amount) which is estimated to be emitted from the third vehicle Trv3 when the commodities are transported from the second base Hb2 to the delivery destination SA1.

The server device 100 may provide information of commodities to the user terminal 200 using a means other than the web server. For example, information of commodities may be provided from the server device 100 to the user terminal 200 using an application program installed in the user terminal 200 and a predetermined protocol.

The server device 100 that realizes the aforementioned functions includes a processor 101, a main storage unit 102, an auxiliary storage unit 103, and a communication unit 104 as illustrated in FIG. 3. The processor 101, the main storage unit 102, the auxiliary storage unit 103, and the communication unit 104 are connected to each other via a bus. The hardware configuration of the server device 100 is not limited to the example illustrated in FIG. 3, and omissions, replacements, and additions of a constituent element may be appropriately performed thereon.

The server device 100 realizes the aforementioned functions by causing the processor 101 to load a program stored in the auxiliary storage unit 103 to a work area of the main storage unit 102 and to execute the program. A series of processes which are performed by the server device 100 may be realized in hardware or may be realized in software.

The processor 101 is, for example, a central processing unit (CPU) or a digital signal processor (DSP). The processor 101 controls the server device 100 by performing operations of processing various types of information.

The main storage unit 102 is a computer-readable recording medium. The main storage unit 102 is a storage device that is used as a recording area to which a program stored in the auxiliary storage unit 103 is loaded or as a buffer in which operation results or the like of the processor 101 are temporarily stored. The main storage unit 102 includes, for example, a random access memory (RAM) and a read only memory (ROM).

The auxiliary storage unit 103 is a computer-readable recording medium. The auxiliary storage unit 103 stores various programs and various types of data and various types of tables used for the processor 101 to execute the various programs. The auxiliary storage unit 103 includes, for example, an erasable programmable ROM (EPROM) or a hard disk drive (HDD). The auxiliary storage unit 103 may include removable media, that is, portable media. For example, the removable media may be a disk recording medium such as a compact disc (CD) or a digital versatile disc (DVD) or may be a universal serial bus (USB) memory. The programs stored in the auxiliary storage unit 103 include programs for realizing the functions of the web server in addition to an operating system (OS). Some or all of information stored in the auxiliary storage unit 103 may be stored in the main storage unit 102.

The communication unit 104 is an interface that is used to connect the server device 100 to the network N1. The communication unit 104 according to this embodiment is connected to the network N1 and communicates with the user terminal 200 via the network N1. The communication unit 104 is, for example, a local area network (LAN) interface board or a wireless communication circuit for wireless communication. The network N1 is, for example, a wide area network (WAN) which is a global public communication network such as the Internet or another communication network.

The user terminal 200 is a computer that is used by a user who uses the selling site. The user terminal 200 is, for example, a personal computer, a smartphone, a mobile phone, a tablet computer, or a wearable device. The user terminal 200 in this embodiment performs an interaction with the user. Specifically, the user terminal 200 realizes a function of accessing the selling site via the server device 100 and presenting a web page in which information of commodities is displayed to the user, a function of receiving a purchase request for a commodity selected by the user, and a function of transmitting the purchase request for a commodity selected by the user to the server device 100. These functions are realized, for example, by a web browser that operates in the user terminal 200 or an application program that is installed in the user terminal 200.

The user terminal 200 that realizes the aforementioned functions includes a processor 201, a main storage unit 202, an auxiliary storage unit 203, an input and output unit 204, and a communication unit 205 as illustrated in FIG. 3. The processor 201, the main storage unit 202, the auxiliary storage unit 203, the input and output unit 204, and the communication unit 205 are connected to each other via a bus. The configuration of the user terminal 200 is not limited to the example illustrated in FIG. 3, and omissions, replacements, and additions of a constituent element may be appropriately performed thereon.

The processor 201, the main storage unit 202, and the auxiliary storage unit 203 have the same configurations as the processor 101, the main storage unit 102, and the auxiliary storage unit 103 of the server device 100, and thus description thereof will be omitted. Programs stored in the auxiliary storage unit 203 of the user terminal 200 may include the application program for realizing an interaction in addition to an OS.

The input and output unit 204 receives an input operation performed by the user and presents information to the user. The input and output unit 204 includes, for example, a touch panel display and a control circuit thereof. In this embodiment, the input and output unit 204 displays a web page of a selling site on the touch panel display.

The communication unit 205 is an interface that is used to connect the user terminal 200 to the network N1. The communication unit 205 according to this embodiment is connected to the network N1 and communicates with the server device 100 via the network N1. The communication unit 205 is, for example, a Local Area Network (LAN) interface board or a wireless communication circuit for wireless communication. The communication unit 205 may connect the user terminal 200 to the network N1 using a mobile communication network such as 6th-Generation (6G), 5th-Generation (5G), or long-term evolution (LTE).

Functional Configuration of Server Device

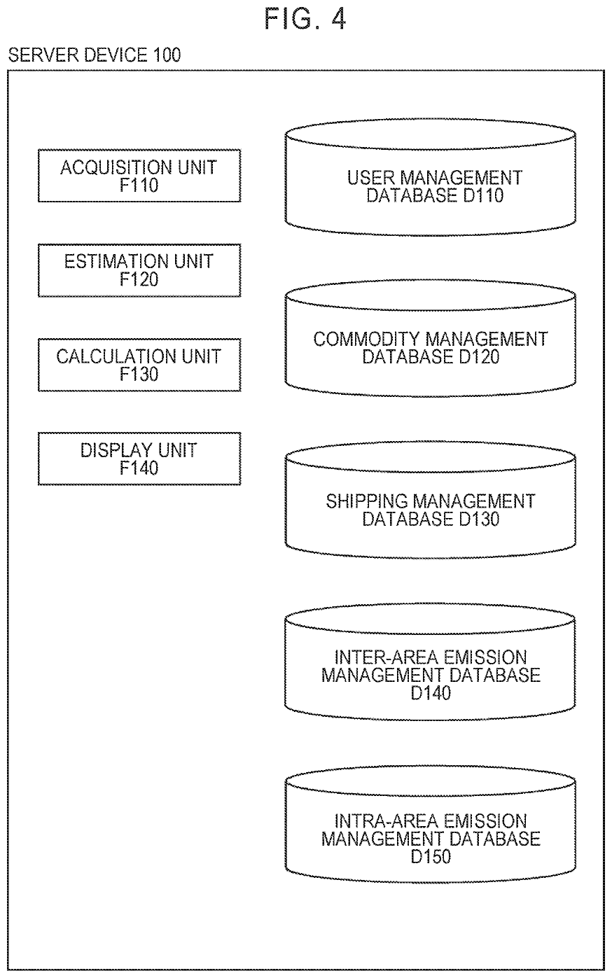

The functional configuration of the server device 100 according to this embodiment will be described below with reference to FIG. 4. FIG. 4 is a block diagram illustrating an example of the functional configuration of the server device 100 according to the embodiment. As illustrated in FIG. 4, the server device 100 according to this embodiment includes a user management database D110, a commodity management database D120, a shipping management database D130, an inter-area emission management database D140, an intra-area emission management database D150, an acquisition unit F110, an estimation unit F120, a calculation unit F130, and a display unit F140 as functional constituents.

The user management database D110, the commodity management database D120, the shipping management database D130, the inter-area emission management database D140, and the intra-area emission management database D150 are constructed by causing a program of a database management system (DBMS) executed by the processor 101 to manage data stored in the auxiliary storage unit 103. At this time, the user management database D110, the commodity management database D120, the shipping management database D130, the inter-area emission management database D140, and the intra-area emission management database D150 may be constructed as regional databases.

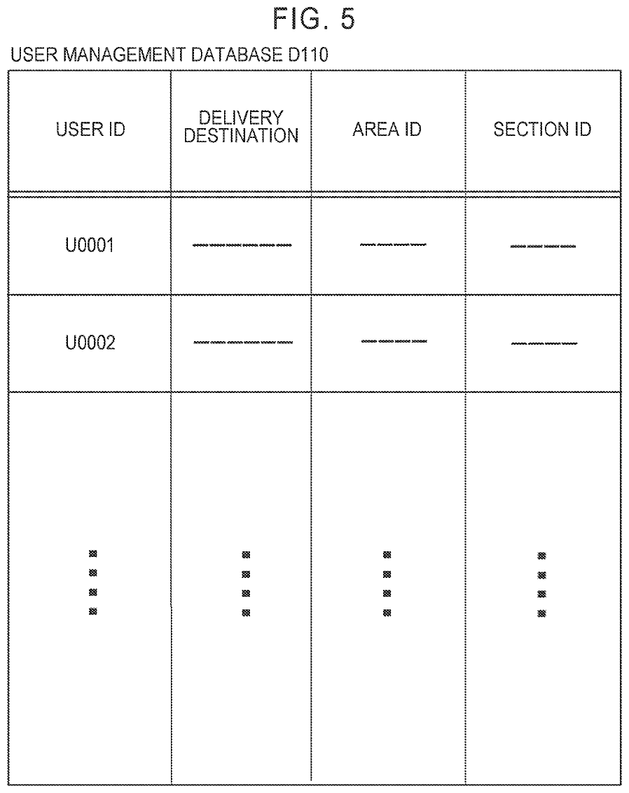

The user management database D110 is a database in which information of users who can use the selling site is stored. FIG. 5 is a diagram illustrating an example of information which is stored in the user management database D110. In the user management database D110 illustrated in FIG. 5, a plurality of records corresponding to a plurality of users who can use the selling site is stored. Each record in the user management database D110 includes fields of user ID, delivery destination, area ID, and section ID. These records are generated and stored in the user management database D110 when the users perform member registration in the selling site.

In the field of user ID, information (user IDs) for individually identifying a plurality of users who can use the selling site is registered. The user IDs are information which is set when the users perform member registration in the selling site and are also used as login IDs when the users log in on the selling site.

In the field of delivery destination, information indicating a delivery destination SA1 of a commodity purchased in the selling site by each user is registered. In the field of delivery destination, for example, information indicating an address of a delivery destination SA1 designated by each user (for example, a home of a user or a work place of a user) is registered. Information registered in the field of delivery destination is not limited to the information indicating an address of a delivery destination SA1 as long as it can identify a delivery destination SA1 designated by each other. For example, when a delivery destination SA1 designated by a user is a delivery box, information for identifying the delivery box may be registered in the field of delivery destination.

In the field of area ID, information (an area ID) for identifying an area (a second area in FIG. 2) including a delivery destination SA1 of each user is registered. An area mentioned herein is an individual geographical subarea when a territory is divided into geographical subareas taken charge of by the bases of a delivery agent (business offices such as a delivery center) as described above with reference to FIG. 2.

In the field of section ID, information (a section ID) for identifying a section including a delivery destination SA1 for each user is registered. A section mentioned herein is an individual geographical subarea when each area is divided into a plurality of geographical subareas in consideration of efficiency of delivery work by a delivery agent or the like as described above with reference to FIG. 2.

A configuration of each record stored in the user management database D110 is not limited to the example illustrated in FIG. 5, and addition, change, or deletion of a field can be appropriately performed thereon. For example, the records stored in the user management database D110 may include, a field in which information such as sex of a user, age of a user, a password for a user to log in on the selling site, or a price payment method of commodity is registered in addition to the aforementioned fields.

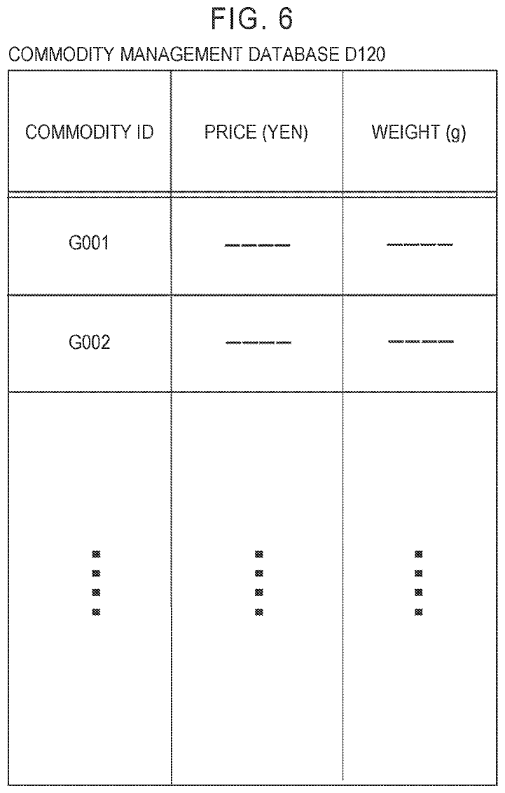

The commodity management database D120 is a database in which information of commodities sold in the selling site is stored. FIG. 6 is a diagram illustrating an example of information which is stored in the commodity management database D120. In the commodity management database D120 illustrated in FIG. 6, a plurality of records corresponding to a plurality of commodities sold in the selling site is stored. Each record in the commodity management database D120 includes fields of commodity ID, price, and weight.

In the field of commodity ID, information (commodity IDs) for individually identifying a plurality of commodities sold in the selling site is registered. In the field of price, information indicating prices of the commodities sold in the selling site is registered. In the field of weight, information indicating weights of the commodities sold in the selling site is registered.

A configuration of each record stored in the commodity management database D120 is not limited to the example illustrated in FIG. 6, and addition, change, or deletion of a field can be appropriately performed thereon. For example, each record stored in the commodity management database D120 may include a field in which information such as photographs of commodities, explanations of commodities, or sizes of commodities is registered in addition to the aforementioned fields.

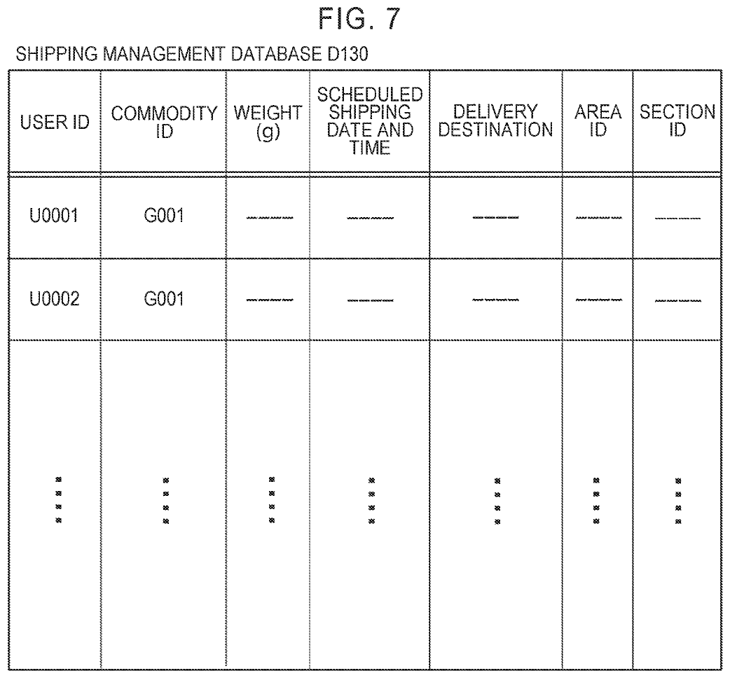

The shipping management database D130 is a database in which information of commodities which have not been yet shipped out of commodities purchased in the selling site is stored for each user purchasing the commodities. FIG. 7 is a diagram illustrating an example of information which is stored in the shipping management database D130. In the shipping management database D130 illustrated in FIG. 7, a plurality of records corresponding to a plurality of users having purchased commodities in the selling site is stored. Each record in the shipping management database D130 includes fields of user ID, commodity ID, weight, scheduled shipping date and time, delivery destination, area ID, and section ID. These records are generated and stored in the shipping management database D130 whenever a purchase request transmitted from a user terminal 200 is received by the communication unit 104 of the server device 100. Each record in the shipping management database D130 is deleted from the shipping management database D130 at a time point at which shipping of the corresponding commodity has been completed.

In the field of user ID, a user ID of a user having purchased a commodity in the selling site is registered. The same as the user ID registered in the field of user ID in the record corresponding to the user out of the records stored in the user management database D110 is used as the user ID mentioned herein.

In the field of commodity ID, a commodity ID of a commodity purchased in the selling site by each user is registered. The same as the commodity ID registered in the field of commodity ID in the record corresponding to the commodity out of the records stored in the commodity management database D120 is used as the commodity ID mentioned herein. When the same user purchases a plurality of commodities in the selling site and the scheduled shipping date and times of the purchased commodities are the same, commodity IDs of the plurality of commodities are registered in the field of commodity ID in the record corresponding to the user.

In the field of weight, information indicating a weight of a commodity purchased in the selling site by each user is registered. The same as the information registered in the field of weight in the record corresponding to the commodity out of the records stored in the commodity management database D120 is used as the information indicating the weight mentioned herein. Information indicating a total weight in which weights of a plurality of commodities are summed is registered in the field of weight in a record in which a plurality of commodity IDs is registered in the field of commodity ID.

In the field of scheduled shipping date and time, information indicating a scheduled shipping date and time of a commodity purchased in the selling site by each user is registered. In this embodiment, information indicating a date and time at which the first vehicle Trv1 on which the commodity has been loaded in the shipping source SS1 is scheduled to depart from the shipping source SS1 is registered.

In the field of delivery destination, information of a delivery destination SA1 of a commodity purchased in the selling site by each user is registered. The same as the information registered in the field of delivery destination in the record corresponding to the user out of the records stored in the user management database D110 is used as the information of the delivery destination SA1 mentioned herein.

In the field of area ID, an area ID of an area (a second area in FIG. 2) including a delivery destination SA1 of a commodity purchased in the selling site by each user is registered. The same as the area ID registered in the field of area ID in the record corresponding to the user out of the records stored in the user management database D110 is used as the area ID mentioned herein.

In the field of section ID, a section ID of a first section in FIG. 2 including a delivery destination SA1 of a commodity purchased in the selling site by each user is registered. The same as the section ID registered in the field of section ID in the record corresponding to the user out of the records stored in the user management database D110 is used as the section ID mentioned herein.

A configuration of each record stored in the shipping management database D130 is not limited to the example illustrated in FIG. 7, and addition, change, or deletion of a field can be appropriately performed thereon. For example, each record stored in the shipping management database D130 may include a field in which information such as prices of commodities, sizes of commodities, or price payment method of commodities is registered in addition to the aforementioned fields.

The inter-area emission management database D140 stores a third emissions amount for each delivery destination area. The delivery destination area mentioned herein is an area (an area corresponding to the second area in FIG. 2) in which a base being able to serve as a receiver of commodities transported from the first base Hb1 by the second vehicle Trv2 is located out of areas taken charge of by the bases of the delivery agents. This delivery destination area includes an area other than the first area out of the plurality of areas divided as described above. The third emissions amount is an amount of carbon dioxide which is estimated to be emitted from the second vehicle Trv2 when it is assumed that the commodities sold in the selling site are transported from the first area to the delivery destination area. Specifically, the third emissions amount is an amount of carbon dioxide which is estimated to be emitted from the second vehicle Trv2 when it is assumed that the commodities sold in the selling site are transported from the first base Hb1 to a base of the delivery destination area (a base corresponding to the second base Hb2 in FIG. 2) by the second vehicle Trv2.

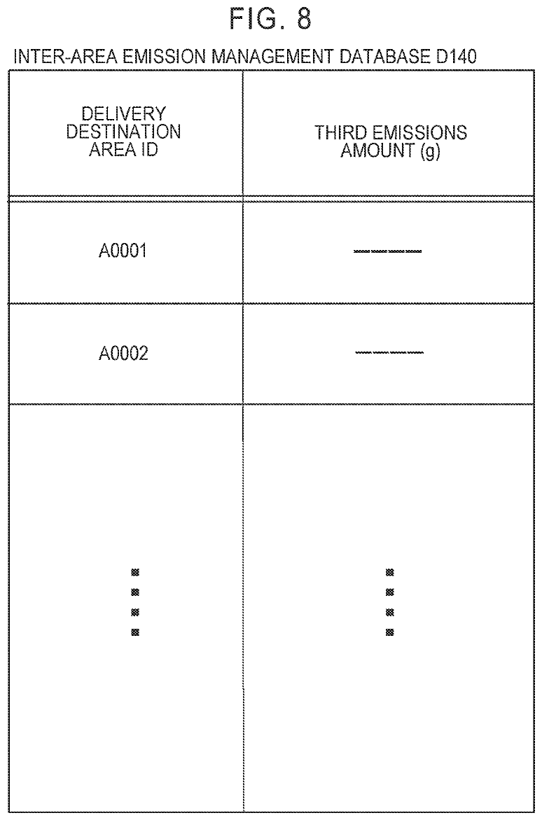

FIG. 8 is a diagram illustrating an example of information which is stored in the inter-area emission management database D140. In the inter-area emission management database D140 illustrated in FIG. 8, a plurality of records corresponding to a plurality of delivery destination areas is stored. Each record in the inter-area emission management database D140 includes fields of delivery destination area ID and third emissions amount.

In the field of delivery destination area ID, an area ID of each delivery destination area is registered. In the field of third emissions amount, an amount of carbon dioxide (a third emissions amount) which is estimated to be emitted from the second vehicle Trv2 when it is assumed that the commodities sold in the selling site are transported from the first base Hb1 to the base of each delivery destination area is registered. In this embodiment, a historical average value of amounts of carbon dioxide emitted from the second vehicle Trv2 when the second vehicle Trv2 has traveled actually from the first base Hb1 to the base of each delivery destination area is used as the third emissions amount. The third emissions amount may be provided, for example, by a delivery agent taking charge of inter-area transportation from the first base Hb1 to the base of each delivery destination area.

A configuration of each record stored in the inter-area emission management database D140 is not limited to the example illustrated in FIG. 8, and addition, change, or deletion of a field can be appropriately performed thereon.

The intra-area emission management database D150 stores a fourth emissions amount for each delivery destination section in a delivery destination area. The delivery destination section mentioned herein is a section (a section corresponding to the first section in FIG. 2) including a delivery destination SA1 out of a plurality of sections in each delivery destination area. This delivery destination section includes all sections in the delivery destination area. The fourth emissions amount is an amount of carbon dioxide which is estimated to be emitted from the third vehicle Trv3 when it is assumed that the commodities sold in the selling site are transported from the base of a delivery destination area to the delivery destination SA1. In this embodiment, an amount of carbon dioxide which is estimated to be emitted from the third vehicle Trv3 when it is assumed that the commodities sold in the selling site are transported from the base of a delivery destination area to the delivery destination section by the third vehicle Trv3 is used as the fourth emissions amount.

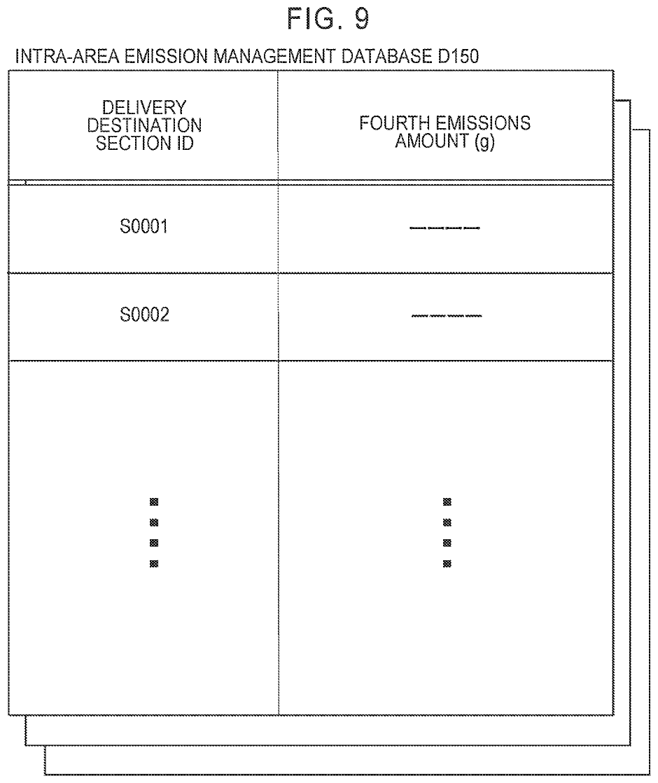

FIG. 9 is a diagram illustrating an example of information which is stored in the intra-area emission management database D150. In the intra-area emission management database D150 illustrated in FIG. 9, a plurality of tables is stored to correspond to the delivery destination areas. In each table, a plurality of records corresponding to a plurality of delivery destination sections in each delivery destination area is stored. Each record in each table of the intra-area emission management database D150 includes fields of delivery destination section ID and fourth emissions amount.

In the field of delivery destination section ID, a section ID of each delivery destination area is registered. In the field of fourth emissions amount, an amount of carbon dioxide (a fourth emissions amount) which is estimated to be emitted from the third vehicle Trv3 when it is assumed that the commodities sold in the selling site are transported from the base of each delivery destination area to the corresponding delivery destination section is registered. In this embodiment, a historical average value of amounts of carbon dioxide emitted from the third vehicle Trv3 when the third vehicle Trv3 has traveled actually from the base of each delivery destination area to the corresponding delivery destination section is used as the fourth emissions amount. The fourth emissions amount may be provided, for example, by a delivery agent taking charge of transportation in the delivery destination area.

A configuration of each record stored in the intra-area emission management database D150 is not limited to the example illustrated in FIG. 9, and addition, change, or deletion of a field can be appropriately performed thereon.

Description with reference to FIG. 4 will be back. The acquisition unit F110, the estimation unit F120, the calculation unit F130, and the display unit F140 are realized by causing the processor 101 of the server device 100 to load a program in the auxiliary storage unit 103 to the main storage unit 102 and to execute the program. The acquisition unit F110, the estimation unit F120, the calculation unit F130, and the display unit F140 may be realized by a hardware circuit such as an application-specific integrated circuit (ASIC) or a field-programmable gate array (FPGA). In this embodiment, the processor 101 that realizes the functional constituents of the acquisition unit F110, the estimation unit F120, the calculation unit F130, and the display unit F140 corresponds to a “control unit” in the claims.

The acquisition unit F110 acquires a first weight with login of a user on the selling site (start of browsing of the web page of the selling site) as a trigger. The first weight is a total weight of commodities which are purchased in the selling site in a first period from a start timing of a predetermined period to a present point of time. The predetermined period is a period in which commodities (commodities of which a purchase request has been received) purchased in the predetermined period is determined to be loaded on the first vehicle Trv1 at a preset shipping timing and to be shipped.

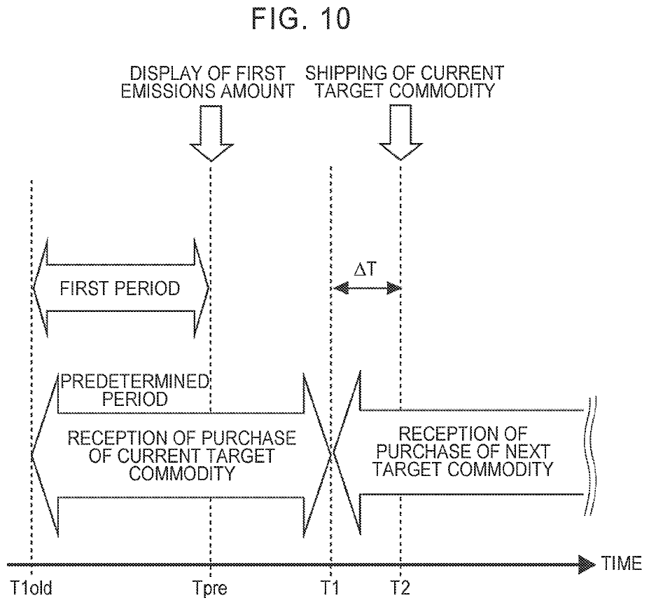

The predetermined period and the first period will be specifically described below with reference to FIG. 10. FIG. 10 is a diagram illustrating the predetermined period and the first period when commodities sold in the selling site are shipped at time T2 every day. ΔT in FIG. 10 denotes a time length required for a shipping preparing operation (such as picking and packing of commodities). Tpre in FIG. 10 denotes a timing (a present point of time) at which a user starts browsing a web page (a web page for selling commodities) of the selling site. The timing at which the user starts browsing the web page of the selling site may be a timing at which the user logs in on the selling site.

In the example illustrated in FIG. 10, purchase reception of commodities to be shipped at a shipping time T2 is finished at time T1 which is earlier by a time length ΔT than the shipping time T2. Accordingly, commodities purchased in the selling site in a period from time T1 of a previous day (T1old in FIG. 10) to time T1 of a shipping day is a commodity to be shipped at the shipping time T2. As a result, the period from time T1old to time T1 becomes the predetermined period. That is, time T1 old is a start timing of the predetermined period, and time T1 is an end timing of the predetermined period. The period from time T1 old to the present point of time Tpre (the timing at which the user starts browsing the web page of the selling site) is the first period.

Accordingly, in the example illustrated in FIG. 10, the acquisition unit F110 acquires the total weight of commodities purchased in the selling site from time T1old to the present point of time Tpre as a first weight. Specifically, the acquisition unit F110 accesses the shipping management database D130 and extracts all records in which a date and time registered in the field of scheduled shipping date and time matches time T2 of the shipping day. The acquisition unit F110 reads a weight registered in the field of weight of all the extracted records. The acquisition unit F110 acquires the first weight by summing all the read weights. The first weight acquired by the acquisition unit F110 is sent from the acquisition unit F110 to the estimation unit F120.

Description with reference to FIG. 4 will be back. The estimation unit F120 estimates the second emissions amount based on the first weight received from the acquisition unit F110. The second emissions amount is an amount of carbon dioxide which is estimated to be emitted from the first vehicle Trv1 w when it is assumed that a commodity (a first commodity) browsed at the present point of time Tpre by the user is purchased at the present point of time and the first commodity is loaded on the first vehicle Trv1 and transported from the shipping source SS1 to the first base Hb1.

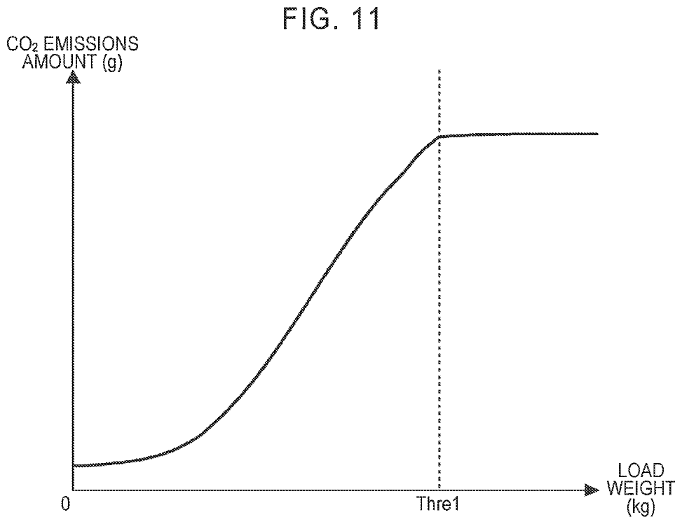

A correlation between an amount of carbon dioxide (a CO₂ emissions amount) emitted from the first vehicle Trv1 and a load weight of the first vehicle Trv1 when the first vehicle Trv1 travels from the shipping source SS1 to the first base Hb1 is illustrated in FIG. 11. When the load weight of the first vehicle Trv1 is less than a predetermined threshold value Thre1, the CO₂ emissions amount increases as the load weight increases. When the load weight of the first vehicle Trv1 is equal to or greater than the predetermined threshold value Thre1, the CO₂ emissions amount is substantially constant or a rate of increase of the CO₂ emissions amount decreases greatly even when the load weight increases. This is because a unit emissions amount (an amount of carbon dioxide emitted from a vehicle per unit distance (for example, 1 km)) in a vehicle used to transport commodities such as the first vehicle Trv1 increases with an increase of the load weight and the unit emissions amount tends to be substantially constant regardless of the magnitude of the load weight when the load weight is equal to or greater than the predetermined threshold value.

Therefore, the estimation unit F120 first determines whether the first weight is equal to or greater than the predetermined threshold value Thre1. When the first weight is less than the predetermined threshold value, the estimation unit F120 calculates a second weight which is a weight obtained by summing the first weight and the weight of the first commodity. The weight of the first commodity is derived from the commodity management database D120. Specifically, the estimation unit F120 accesses the commodity management database D120 with a commodity ID of the first commodity displayed in the web page browsed by the user at the present point of time Tpre as an argument. The estimation unit F120 identifies a record in which information registered in the field of commodity ID matches the commodity ID of the first commodity out of the records stored in the commodity management database D120. The estimation unit F120 reads the weight registered in the field of weight in the identified record. The estimation unit F120 calculates the second weight by summing the read weight of the first commodity and the first weight.

The estimation unit F120 estimates the second emissions amount based on the correlation between the first weight and the second weight illustrated in FIG. 11. Specifically, the estimation unit F120 calculates the CO₂ emissions amount when it is assumed that the load weight of the first vehicle Trv1 is equal to the first weight based on the correlation illustrated in FIG. 11. The estimation unit F120 calculates the CO₂ emissions amount when it is assumed that the load weight of the first vehicle Trv1 is equal to the second weight based on the correlation illustrated in FIG. 11. In this calculation, the correlation illustrated in FIG. 11 may be stored in advance in the auxiliary storage unit 103 of the server device 100 in the form of a map or a function expression. The estimation unit F120 estimates the second emissions amount by subtracting the CO₂ emissions amount when it is assumed that the load weight of the first vehicle Trv1 is equal to the first weight from the CO₂ emissions amount when it is assumed that the load weight of the first vehicle Trv1 is equal to the second weight. When the first weight is equal to or greater than the predetermined threshold value, the estimation unit F120 estimates that the second emissions amount is a predetermined minimum value (for example, “0”). The second emissions amount estimated by the estimation unit F120 is sent from the estimation unit F120 to the calculation unit F130.

Description with reference to FIG. 4 will be back. The calculation unit F130 calculates the first emissions amount based on the second emissions amount received from the estimation unit F120. The first emissions amount is an amount of carbon dioxide which is estimated to be emitted from the vehicle Try when it is assumed that the first commodity is transported from the shipping source SS1 to the delivery destination SA1 using a vehicle Try. The calculation unit F130 in this embodiment calculates the first emissions amount by summing the second emissions amount, the third emissions amount, and the fourth emissions amount.

The third emissions amount is an amount of carbon dioxide which is estimated to be emitted from the second vehicle Trv2 when the first commodity is transported from the first base Hb1 to the second base Hb2. The fourth emissions amount is an amount of carbon dioxide which is estimated to be emitted from the third vehicle Trv3 when it is assumed that the first commodity is transported from the second base Hb2 to the first section. In estimating the third emissions amount and the fourth emissions amount, first, the calculation unit F130 accesses the user management database D110 with a user ID of a user browsing the web page for the first commodity as an argument. The calculation unit F130 identifies a record in which information registered in the field of user ID matches the user ID of the user out of the records stored in the user management database D110. The calculation unit F130 extracts information (the area ID and the section ID) registered in the field of area ID and the field of section ID of the identified record.

The calculation unit F130 accesses the inter-area emission management database D140 with the extracted area ID as an argument and identifies a record in which information registered in the field of delivery destination area ID matches the area ID. The calculation unit F130 extracts information (the third emissions amount) registered in the field of third emissions amount in the identified record. The calculation unit F130 accesses the intra-area emission management database D150 with the extracted area ID as an argument and identifies a table corresponding to the area ID. The calculation unit F130 identifies a record in which information registered in the field of delivery destination section ID matches the extracted section ID out of the records stored in the identified table. The calculation unit F130 extracts information (the fourth emissions amount) registered in the field of fourth emissions amount in the identified record.

The calculation unit F130 calculates the first emissions amount by adding the extracted third emissions amount and the extracted fourth emissions amount to the second emissions amount estimated by the estimation unit F120. The first emissions amount calculated by the calculation unit F130 is sent from the calculation unit F130 to the display unit F140.

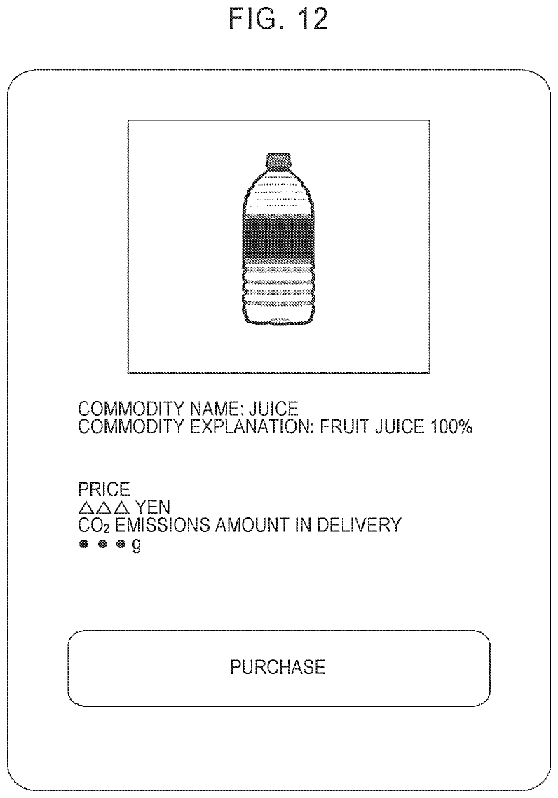

The display unit F140 displays the first emissions amount calculated by the calculation unit F130 in the web page of the first commodity. An example of the web page for the first commodity will be described below with reference to FIG. 12. FIG. 12 is a diagram illustrating an example of the web page for the first commodity displayed via the browser of the user terminal 200. In the example illustrated in FIG. 12, commodity information including a photograph of the first commodity, an explanation of the first commodity, a price of the first commodity, and a CO₂ emissions amount (the first emissions amount) at the time of delivery is displayed in the web page for the first commodity. A button “purchase” in addition to the commodity information is displayed in the web page for the first commodity. When a user selects the button “purchase” via the user terminal 200, the purchase request for the first commodity is transmitted from the user terminal 200 to the server device 100, and a screen for performing a procedure of purchasing the first commodity is displayed on the browser of the user terminal 200.

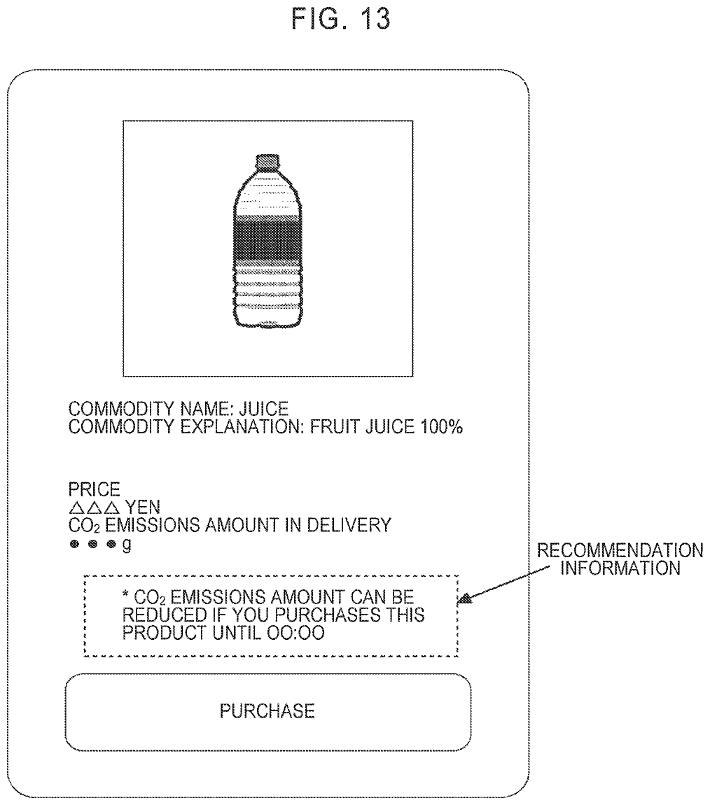

When the estimation unit F120 estimates that the second emissions amount is a predetermined minimum value, the display unit F140 displays recommendation information in addition to the commodity information and the button “purchase” in the web page for the first commodity. FIG. 13 is a diagram illustrating an example of the web page for the first commodity displayed on the browser of the user terminal 200 when the second emissions amount is estimated to be the predetermined minimum value. In the example illustrated in FIG. 13, recommendation information in addition to the commodity information and the button “purchase” is displayed in the web page for the first commodity. The recommendation information is information for recommending that the first commodity is purchased until a predetermined time. The predetermined time is a time indicating the end timing (for example, T1 in FIG. 10) of the predetermined period.

When the user continues to browse the web page for the first commodity, there is a likelihood that any commodity sold in the selling site will be purchased by another user in the period from start of browsing the web page to the present point of time. In this case, the first weight changes while the user is browsing the web page. There is a likelihood that an end time T1 of the predetermined period will come in the period from the start of browsing the web page by the user to the present point of time. In this case, the first weight is reset at the end time T1 of the predetermined period (a start timing of the next predetermined period), and the total weight of commodities purchased in the selling site from the end time T1 to the present point of time (commodities which are shipped at the next shipping time) is the first weight. As a result, the first weight changes while the user is browsing commodities in the web page.

When the first weight changes for this reason while the user is browsing the web page for the first commodity, acquisition of the first weight in the acquisition unit F110, estimation of the second emissions amount in the estimation unit F120, and calculation of the first emissions amount in the calculation unit F130 are performed again. The display unit F140 changes the first emissions amount displayed in the web page for the first commodity to the first emissions amount corresponding to the changed first weight.

One functional constituent of the server device 100 or some of the processes performed thereby may be performed by another computer connected to the network N1. The functional configuration of the server device 100 is not limited to the example illustrated in FIG. 4, and omission, modification, or addition of a functional constituent can be appropriately performed thereon.

Process Routine

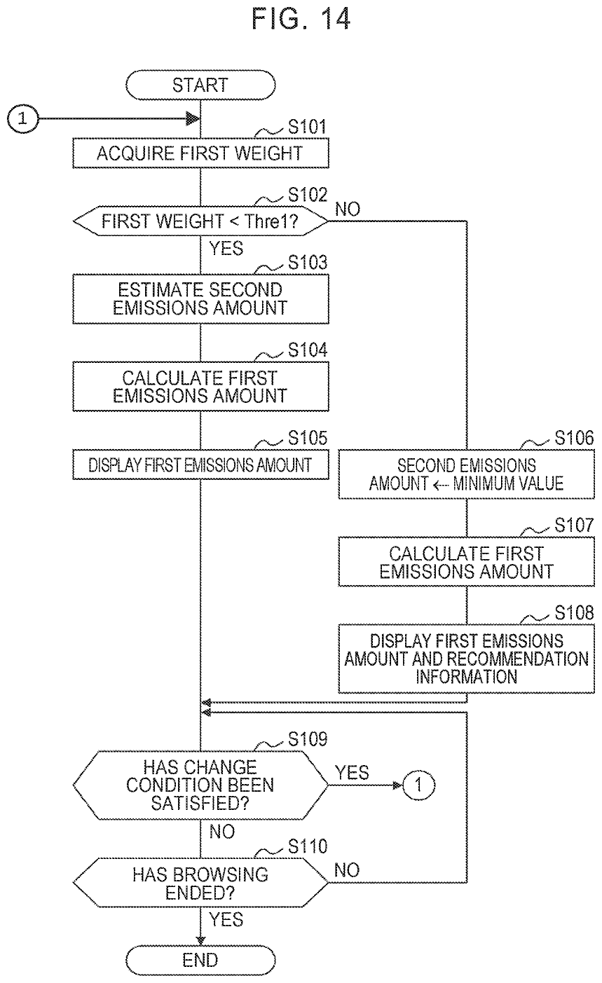

A process routine which is performed by the server device 100 according to this embodiment will be described below with reference to FIG. 14. FIG. 14 is a flowchart illustrating a process routine which is performed by the server device 100 with login of the user on the selling site as a trigger. An execution entity of the process routine illustrated in FIG. 14 is the processor 101 of the server device 100, and the functional constituents of the server device 100 are described as an entity.

In the process routine illustrated in FIG. 14, the acquisition unit F110 acquires the first weight (Step S101). The first weight is a total weight of commodities which have been purchased in the selling site in the first period from the start time of the predetermined period to the present point of time (for example, a period from T1old to Tpre in FIG. 10). Specifically, the acquisition unit F110 accesses the shipping management database D130 and extracts all records in which the date and time registered in the field of scheduled shipping date and time matches the shipping time (for example, T2 in FIG. 10). The acquisition unit F110 reads the weights registered in the field of weight in all the extracted records. The acquisition unit F110 acquires the first weight by summing all the read weights. The first weight acquired by the acquisition unit F110 is sent from the acquisition unit F110 to the estimation unit F120. The estimation unit F120 performs the process of Step S102 with reception of the first weight as a trigger.

In Step S102, the estimation unit F120 determines whether the first weight is less than a predetermined threshold value Thre1. The predetermined threshold value Thre1 is a value at which the CO₂ emissions amount is substantially constant or the rate of increase of the CO₂ emissions amount becomes very small in spite of an increase of the load weight when the load weight of the first vehicle Trv1 is equal to or greater than the predetermined threshold value Thre1 as described above with reference to FIG. 11. When the first weight is less than the predetermined threshold value Thre1 (when the determination result of Step S102 is positive), the estimation unit F120 performs the process of Step S103.

In Step S103, the estimation unit F120 estimates the second emissions amount based on the first weight. The second emissions amount is an amount of carbon dioxide which is estimated to be emitted from the first vehicle Trv1 when it is assumed that a commodity (a first commodity) browsed at the present point of time (for example, the present point of time Tpre in FIG. 10) is purchased by a user at the present point of time and when the first commodity is loaded on the first vehicle Trv1 and transported from the shipping source SS1 to the first base Hb1. The estimation unit F120 first accesses the commodity management database D120 with the commodity ID of the first commodity as an argument. The estimation unit F120 identifies a record in which information registered in the field of commodity ID matches the commodity ID of the first commodity out of the records stored in the commodity management database D120. The estimation unit F120 reads the weight registered in the field of weight in the identified record. The estimation unit F120 calculates the second weight by summing the weight of the first commodity and the first weight.

The estimation unit F120 estimates the second weight based on the first weight, the second weight, and the correlation illustrated in FIG. 11. Specifically, the estimation unit F120 calculates a CO₂ emissions amount when it is assumed that the load weight of the first vehicle Trv1 is equal to the first weight based on the correlation illustrated in FIG. 11. The estimation unit F120 calculates a CO₂ emissions amount when it is assumed that the load weight of the first vehicle Trv1 is equal to the second weight based on the correlation illustrated in FIG. 11. The estimation unit F120 estimates the second emissions amount by subtracting the CO₂ emissions amount when it is assumed that the load weight of the first vehicle Trv1 is equal to the first weight from the CO₂ emissions amount when it is assumed that the load weight of the first vehicle Trv1 is equal to the second weight.

The second emissions amount estimated by the estimation unit F120 is sent from the estimation unit F120 to the calculation unit F130. The calculation unit F130 performs the process of Step S104 with reception of the second emissions amount as a trigger.

In Step S104, the calculation unit F130 calculates the first emissions amount based on the second emissions amount. The first emissions amount is an amount of carbon dioxide which is estimated to be emitted from the vehicle Try when it is assumed that the first commodity is transported from the shipping source SS1 to the delivery destination SA1 using a vehicle Try. The calculation unit F130 first accesses the user management database D110 with the user ID of the user browsing the web page for the first commodity (the user ID which has bene input when the user has logged in the selling site) as an argument. The calculation unit F130 identifies a record in which information registered in the field of user ID matches the user ID of the user out of records stored in the user management database D110. The calculation unit F130 extracts an area ID and a section ID registered in the field of area ID and the field of section ID in the identified record.

The calculation unit F130 accesses the inter-area emission management database D140 with the extracted area ID as an argument and identifies a record in which information registered in the field of delivery destination area ID matches the area ID. The calculation unit F130 extracts information (a third emissions amount) registered in the field of third emissions amount in the identified record.

The calculation unit F130 accesses the intra-area emission management database D150 with the extracted area ID as an argument and identifies a table corresponding to the area ID. The calculation unit F130 identifies a record in which information registered in the field of delivery destination section ID matches the extracted section ID out of records stored in the identified table. The calculation unit F130 extracts information (a fourth emissions amount) registered in the field of fourth emissions amount in the identified record.

The calculation unit F130 calculates the first emissions amount by adding the extracted third emissions amount and the extracted fourth emissions amount to the second emissions amount estimated in Step S103. The first emissions amount calculated in Step S104 is sent from the calculation unit F130 to the display unit F140. The display unit F140 performs the process of Step S105 with reception of the first emissions amount as a trigger.

In Step S105, the display unit F140 displays the first emissions amount calculated by the calculation unit F130 in the web page for the first commodity. Specifically, the display unit F140 displays commodity information including a photograph of the first commodity, an explanation of the first commodity, a price of the first commodity, and a CO₂ emissions amount (the first emissions amount) at the time of delivery along with the button “purchase” in the web page as described above with reference to FIG. 12.

When it is determined in Step S102 that the first weight is equal to or greater than the predetermined threshold value (when the determination result of Step S102 is negative), the estimation unit F120 performs the process of Step S106. In Step S106, the estimation unit F120 estimates that the second emissions amount is a predetermined minimum value (for example, “0”). The second emissions amount estimated by the estimation unit F120 is sent from the estimation unit F120 to the calculation unit F130. The calculation unit F130 performs the process of Step S107 with reception of the second emissions amount as a trigger.

In Step S107, the calculation unit F130 calculates the first emissions amount by adding the second emissions amount estimated in Step S106 to the third emissions amount and the fourth emissions amount. The method of calculating the third emissions amount and the fourth emissions amount is the same as in Step S104. The first emissions amount calculated in Step S107 is sent from the calculation unit F130 to the display unit F140. At this time, information indicating that the second emissions amount is the predetermined minimum value is also sent from the calculation unit F130 to the display unit F140. The display unit F140 performs the process of Step S108 with reception of information from the calculation unit F130 as a trigger.

In Step S108, the display unit F140 displays the first emissions amount calculated in Step S107 and recommendation information in the web page for the first commodity. Specifically, the display unit F140 displays recommendation information along with the button “purchase” in the web page for the first commodity in addition to the commodity information including the photograph of the first commodity, the explanation of the first commodity, the price of the first commodity, and the CO₂ emissions amount (the first emissions amount) at the time of delivery as described above with reference to FIG. 13.

After the process of Step S105 or S108 has been performed, the acquisition unit F110 performs the process of Step S109. In Step S109, the acquisition unit F110 determines whether changing conditions of the first weight have been satisfied. When any commodity sold in the selling site is purchased by another user in a period from start of browsing of the web page for the first commodity by the user to the present point of time, the acquisition unit F110 determines that the changing conditions have been satisfied (the determination result of Step S109 is positive). When the end time T1 of the predetermined period has come in the period from start of browsing of the web page by the user to the present point of time, the acquisition unit F110 also determines that the changing conditions have been satisfied (the determination result of Step S109 is positive). When the determination result of Step S109 is positive, the processes of Step S102 and steps subsequent thereto are performed again to perform acquisition of the changed first weight, estimation of the second emissions amount based on the changed first weight, and calculation of the first emissions amount based on the changed first weight again. Then, information display in the web page for the first commodity is updated.

When it is determined in Step S109 that the changing conditions have not been satisfied (when the determination result of Step S109 is negative), the display unit F140 performs the process of Step S110. In Step S110, the display unit F140 determines whether the user's browsing the web page for the first commodity has ended. When the button “purchase” in the web page for the first commodity has been operated by the user, when an operation of switching the web page for the first commodity to another web page has been performed by the user, when an operation of logging out the selling site has been performed by the user, and the like, the display unit F140 determines that the user's browsing the web page for the first commodity has ended (the determination result of Step S110 is positive). In this case, the process routine ends. When the aforementioned operations have not been performed by the user, the display unit F140 determines that the user's browsing the web page for the first commodity has not ended (the determination result of Step S110 is negative). In this case, the process of Step S109 is performed again.

According to this embodiment, the first emissions amount corresponding to the total weight of commodities which are scheduled to be loaded on the first vehicle Trv1 at the timing at which the user is browsing the web page for the first commodity can be presented to the user. Accordingly, the user can select the purchase timing of the first commodity with reference to the first emissions amount. For example, the user can purchase the first commodity at the timing at which recommendation information is displayed. Accordingly, it is possible to contribute to a decrease of an amount of carbon dioxide emitted from a vehicle Try when the first commodity is transported from the shipping source SS1 to the delivery destination SA1.

### Modified Examples

In a modified example, an example in which the present disclosure is applied to a transportation mode in which a commodity purchased in the selling site is directly transported from a shipping source to a base of a delivery destination area will be described.

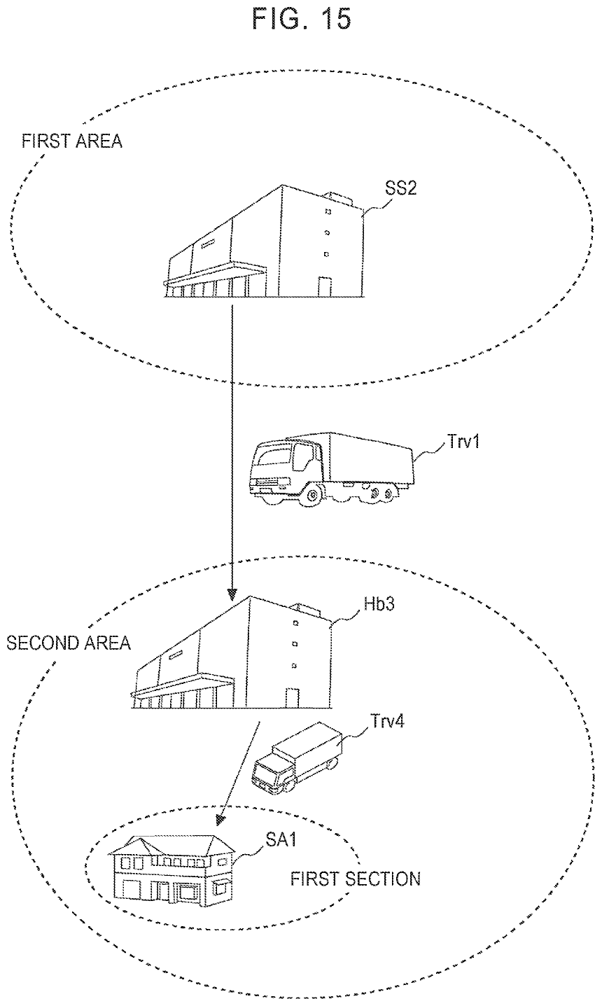

FIG. 15 is a diagram illustrating an example of a routine of transporting a commodity purchased in the selling site from a shipping source to a delivery destination according to the modified example. As illustrated in FIG. 15, a commodity purchased in the selling site according to this modified example is transported from a shipping source SS2 in a first area to a third base Hb3 in a second area (a delivery destination area) using a first vehicle Trv1 and is transported from the third base Hb3 to the delivery destination SA1 in the second area using a fourth vehicle Trv4. This transportation method is suitable for a case in which the shipping source SS2 is a warehouse in which various commodities sold in the selling site are stored or the like. That is, the transportation method illustrated in FIG. 15 is suitable for a case in which an amount of commodities shipped from the shipping source SS2 at a time is large. This is because there is a likelihood that work efficiency will decrease when the commodities are transferred from the first vehicle Trv1 to the second vehicle Trv2 in the first base Hb1 as in the aforementioned embodiment in the case in which the amount of commodities shipped from the shipping source SS2 at a time is large. Similarly to the second base Hb2 in the aforementioned embodiment, the third base Hb3 is a base taking charge of transportation in the second area in which the delivery destination SA1 is located. Similarly to the third vehicle Trv3 in the aforementioned embodiment, the fourth vehicle Trv4 is a vehicle tacking charge of delivery in the first section including the delivery destination SA1.

When a first commodity is transported using the transportation method illustrated in FIG. 15, the acquisition unit F110 and the estimation unit F120 of the server device 100 can perform acquisition of the first weight and estimation of the second emissions amount in the same order as in the aforementioned embodiment. The calculation unit F130 of the server device 100 can estimate an amount of carbon dioxide (a fifth emissions amount) which is estimated to be emitted from the fourth vehicle Trv4 when the first commodity is transported from the third base Hb3 to the first section in the same order as estimating the fourth emissions amount in the aforementioned embodiment. The calculation unit F130 of the server device 100 can calculate the first emissions amount by adding the fifth emissions amount to the second emissions amount estimated by the estimation unit F120.

According to this modified example, the same advantages as in the aforementioned embodiment can be achieved even when the present disclosure is applied to the transportation method illustrated in FIG. 15.

Others

The aforementioned embodiment and the aforementioned modified example are only examples, and the present disclosure can be appropriately modified without departing from the gist thereof. For example, when the first vehicle Trv1 in the embodiment is a vehicle that picks up commodities from a plurality of shipping sources including the shipping source SS1 and transports the commodities to the first base Hb1, the total weight of commodities which are determined to be picked up by the first vehicle Trv1 at the timing at which the user is browsing the web page for the first commodity can be used as the first weight.

The processes and configurations described in the aforementioned embodiment and the aforementioned modified example can be freely combined unless technical conflictions arise. For example, the embodiment and the modified example may be combined. In this case, the server device 100 may calculate the first emissions amount using the method according to the embodiment as for the first commodity which is predicted to be transported using the transportation method according to the embodiment and calculate the first emissions amount using the method according to the modified example as for the first commodity which is predicted to bet transported using the transportation method according to the modified example.

Processes described above to be performed by a single device may be divisionally performed by a plurality of devices. Processes described above to be performed by different devices may be performed by a single device. By what hardware constituents the functions are to be realized can be flexibly changed in a computer system.

The present disclosure can be realized by supplying a computer program having the functions described above in the embodiment to a computer and causing one or more processors of the computer to read and execute the computer program. Such a computer program may be provided to the computer using a non-transitory computer-readable storage medium which can be connected to a system bus of the computer or may be provided to the computer via a network. The non-transitory computer-readable storage medium is a recording medium that can store information such as data and programs and read the information from the computer through an electrical, magnetic, optical, mechanical, or chemical operation. This recording medium may be, for example, an arbitrary type disc such as a magnetic disk (such as a floppy (registered trademark) disk or a hard disk drive (HDD)) and an optical disc (such as a CD-ROM, a DVD disc, or a Blu-ray disc). The recording medium may be a medium such as a read only memory (ROM), a random access memory (RAM), an EPROM, an EEPROM, a magnetic card, a flash memory, an optical card, or a solid state drive (SSD).

What is claimed is:

1. An information processing device that displays a first emissions amount which is an amount of carbon dioxide estimated to be emitted from a vehicle transporting commodities on a selling site of the commodities, the information processing device comprising a control unit configured to perform:
acquiring a first weight which is a total weight of commodities which are scheduled to be loaded on a first vehicle along with a first commodity and to be shipped when the first commodity is assumed to have been purchased at a present time point;
estimating a second emissions amount which is an amount of carbon dioxide emitted from the first vehicle based on the first weight and a weight of the first commodity; and
calculating the first emissions amount corresponding to the first commodity based on the second emissions amount.

2. The information processing device according to claim 1, wherein the first vehicle is a vehicle that transports commodities purchased from the selling site in a predetermined period, and
wherein the commodities which are scheduled to be loaded on the first vehicle along with a first commodity and to be shipped are commodities purchased from the selling site in a first period from a start time of the predetermined period to the present time point in the predetermined period.

3. The information processing device according to claim 2, wherein, when the first weight changes, the control unit is configured to perform:
re-estimating the second emissions amount based on the changed first weight; and
re-calculating the first emissions amount based on the re-estimated second emissions amount.

4. The information processing device according to claim 3, wherein the control unit is configured to estimate that the second emissions amount is a predetermined minimum value when the first weight is equal to or greater than a predetermined threshold value.

5. The information processing device according to claim 4, wherein the control unit is configured to display recommendation information for recommending purchasing of the first commodity on the selling site in correlation with the first commodity when it is estimated that the second emissions amount is the predetermined minimum value.

6. The information processing device according to claim 5, wherein the recommendation information includes information for recommending purchasing of the first commodity until a first time prior to a shipping timing.

7. The information processing device according to claim 1, wherein the first commodity is transported from a shipping source to a first base by the first vehicle, is transported from the first base to a second base by a second vehicle, and is transported from the second base to a delivery destination by a third vehicle, and
wherein the control unit is configured to calculate the first emissions amount by summing the second emissions amount, a third emissions amount which is an amount of carbon dioxide estimated to be emitted from the second vehicle when the first commodity is transported from the first base to the second base, and a fourth emissions amount which is an amount of carbon dioxide estimated to be emitted from the third vehicle when the first commodity is transported from the second base to the delivery destination.

8. The information processing device according to claim 7, wherein the third emissions amount is a historical average value of amounts of carbon dioxide emitted when the second vehicle has actually traveled from the first base to the second base.

9. The information processing device according to claim 7, wherein the fourth emissions amount is a historical average value of amounts of carbon dioxide emitted when the third vehicle has traveled actually from the second base to the delivery destination.

10. The information processing device according to claim 1, wherein the first commodity is transported from a shipping source to a third base by the first vehicle and is transported from the third base to a delivery destination by a fourth vehicle, and
wherein the control unit is configured to calculate the first emissions amount by summing the second emissions amount and a fifth emissions amount which is an amount of carbon dioxide estimated to be emitted from the fourth vehicle when the first commodity is transported from the third base to the delivery destination.

11. The information processing device according to claim 10, wherein the fifth emissions amount is a historical average value of amounts of carbon dioxide emitted when the fourth vehicle has traveled actually from the third base to the delivery destination.

12. An information processing method of displaying a first emissions amount which is an amount of carbon dioxide estimated to be emitted from a vehicle transporting commodities on a selling site of the commodities, the information processing method being performed by a computer, the information processing method comprising:
acquiring a first weight which is a total weight of commodities which are scheduled to be loaded on a first vehicle along with a first commodity and to be shipped when the first commodity is assumed to have been purchased at a present time point;
estimating a second emissions amount which is an amount of carbon dioxide emitted from the first vehicle based on the first weight and a weight of the first commodity; and
calculating the first emissions amount corresponding to the first commodity based on the second emissions amount.

13. The information processing method according to claim 12, wherein the first vehicle is a vehicle that transports commodities purchased from the selling site in a predetermined period, and
wherein the commodities which are scheduled to be loaded on the first vehicle along with a first commodity and to be shipped are commodities purchased from the selling site in a first period from a start time of the predetermined period to the present time point in the predetermined period.

14. The information processing method according to claim 13, wherein, when the first weight changes, the computer is configured to perform:
re-estimating the second emissions amount based on the changed first weight; and
re-calculating the first emissions amount based on the re-estimated second emissions amount.

15. The information processing method according to claim 14, wherein the computer is configured to estimate that the second emissions amount is a predetermined minimum value when the first weight is equal to or greater than a predetermined threshold value.

16. The information processing method according to claim 15, wherein the computer is configured to display recommendation information for recommending purchasing of the first commodity on the selling site in correlation with the first commodity when it is estimated that the second emissions amount is the predetermined minimum value.

17. The information processing method according to claim 16, wherein the recommendation information includes information for recommending purchasing of the first commodity until a first time prior to a shipping timing.

18. The information processing method according to claim 12, wherein the first commodity is transported from a shipping source to a first base by the first vehicle, is transported from the first base to a second base by a second vehicle, and is transported from the second base to a delivery destination by a third vehicle, and
wherein the computer is configured to calculate the first emissions amount by summing the second emissions amount, a third emissions amount which is an amount of carbon dioxide estimated to be emitted from the second vehicle when the first commodity is transported from the first base to the second base, and a fourth emissions amount which is an amount of carbon dioxide estimated to be emitted from the third vehicle when the first commodity is transported from the second base to the delivery destination.

19. The information processing method according to claim 18, wherein the third emissions amount is a historical average value of amounts of carbon dioxide emitted when the second vehicle has traveled actually from the first base to the second base.

20. The information processing method according to claim 18, wherein the fourth emissions amount is a historical average value of amounts of carbon dioxide emitted when the third vehicle has traveled actually from the second base to the delivery destination.
